(19) United States
(12) Patent Application Publication
(10) Pub. No.: US 2021/0283438 A1
(43) Pub. Date: Sep. 16, 2021

(54) Custom-Made Stovetop Protection Set

(71) Applicant: Premium Plus Inc., Seattle, WA (US)

(72) Inventor: Aziz Ahmed Junejo, Seattle, WA (US)

(73) Assignee: Premium Plum, Inc., Seattle, WA (US)

(21) Appl. No.: 17/022,054

(22) Filed: Sep. 15, 2020

Related U.S. Application Data
(60) Provisional application No. 62/874,105, filed on Jul. 15, 2019.

(51) Int. Cl. A62C 3/00; A62C 2/06

(52) U.S. Cl. CPC A62C 3/006; A62C 2/06

(57) ABSTRACT

A fire-resistant cover is configured for placement over a stove top. The cover is composed of three sections, which can be autonomous of or conjoined to each other. This allows for facile cleaning, removal, and placement of the cover on the surface of the stove top. The cover comports to uneven surfaces and heterogeneities on the surface to form a leveled environment.

### CROSS-REFERENCES TO RELATED APPLICATIONS

This application claims the benefit of U.S. Provisional Patent Application No. 62/874,105 filed on Jul. 15, 2019, entitled “Custom-Made Stovetop Protection Set”, which is incorporated herein in its entirety.

### TECHNICAL FIELD

The present invention relates to protective coverings placed on a stovetop.

### BACKGROUND

When operating a stove top, items, such as food or liquid, are likely to: (i) spill, drip, or leak onto the surface of the stovetop; or (ii) get stuck within crevices near burners. These items that are on the surface of the stovetop or stuck within the crevices need to be removed. Failure to perform this removal leads to a disheveled environment, and possible staining of surfaces of the stovetop and even contamination. The application of cleaning solutions for the removal of the items mentioned above can be a tedious endeavor. Then the cleaning solutions need be removed. As with the failure in removing items from the surface of the stovetop or the crevices, the failure in removing cleaning solutions can lead to stained surfaces and contamination. Contamination renders the stovetop unsanitary for use. The stovetop also produces heat, which can cause injury to the individual operating the stovetop and damage the surface of the stovetop. There are uneven portions of the surfaces of the stovetops. This leads to crevices which are difficult to clean and thus further complicating the application of cleaning solutions of the surfaces of the stovetops.

What is needed is a protective cover that is readily placeable and removable from the surface of the stovetop.

### BRIEF SUMMARY OF EMBODIMENTS OF THE INVENTION

In a variant, a cover placed for a stove top comprises: a plurality of sections composed of a fire-resistant polymer, wherein each section comprises: a top layer comprising a first plurality of cutouts and a first plurality of ridges, wherein the first plurality of ridges is disposed on a top surface of the top layer; a bottom layer comprising a second plurality of cutouts and a second plurality of ridges, wherein the second plurality of ridges is disposed on a bottom surface of the bottom layer; a middle layer comprising a third plurality of cutouts, wherein the middle layer is disposed in between a bottom surface of the top layer and a top surface of the bottom layer; wherein the first plurality of cutouts is disposed over the second plurality of cutouts, wherein the second plurality of cutouts is disposed over the third plurality of cutouts; wherein the first plurality of ridges comprises a first arrangement of ridges and a second arrangement of ridges; wherein the second plurality of ridges comprises a first arrangement of ridges and a second arrangement of ridges; and wherein the stove top comprises burners and a housing unit.

In another variant, first plurality of cutouts and the second plurality of cutouts are configured to fit around the burners of the stove top.

In yet another variant, the fire-resistant polymer is polytetrafluoroethylene (PTFE).

In yet another variant, the bottom layer, the middle layer, and the top layer are configured to adopt to uneven surfaces of the housing unit.

In yet another variant, the fire-resistant polymer is non-sticky.

In yet another variant, the second plurality of ridges dissipates heat in contact with the plurality of sections.

In yet another variant, the first and second arrangements of ridges of the top layer are configured to sequester items within the first and second arrangements of ridges of the top layer.

In yet another variant, items comprise liquid and food.

In yet another variant, the heat resistant polymer is certified as: heat resistant per Food and Drug Administration (FDA) standards and absent of perfluorooctanoic acid (PFOA).

Other features and aspects of the invention will become apparent from the description herein, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 and FIG. 2 are depictions of the covers herein, in accordance with the principles of the invention.

FIG. 3 and FIG. 4 are depictions of the layers of the covers herein, in accordance with the principles of the invention.

FIG. 5 is a depiction of a wire diagram where the cover top is placed over a stovetop, in accordance with the principles of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

The systems and methods herein are directed to a protective cover placed over a stovetop. The protective cover is made from polytetrafluoroethylene (PTFE). This variant of PTFE is durable and fire resistant, while also being free of perfluorooctanoic acid (PFOA) certified and Food and Drug Administration (FDA) certified heat resistant. The protective cover herein is arranged to protect multiple burner configurations on stovetops (gas or electric powered). The protective cover herein can be divided into three and four distinct sections to cover, thereby protecting the metal surface of the stovetop. The distinct sections can be placed independently of each other on the surface of the stovetop, or collectively (i.e., slight overlapping) on the surface of the stovetop. There are cutouts in protective covers herein which can fit the variety of burner sizes. The protective covers herein can be easily removed for cleaning in inner stovetop sections. Instead of removing the entirety of heavy grates or removable parts in to clean one dirty section, one of the distinct sections can be removed for cleaning when appropriate. Thus, the stovetops remain intact. Stovetops are not always flush with the top of a counter. Stovetops may have a middle burner section is raised up, thereby making an uneven surface. The protective coverings herein comprise an individual section composed of PTFE configured for uniquely sitting flat in each individual stovetop section area. More specifically, there are ridges on the protective coverings which are composed of a variant to PTFE which can contort to the heterogeneities (e.g., ridges and dips) on the surfaces of the stovetop to make: (i) a sturdy fit; (ii) a structural basis for the flattening surface; (iii) a heat dissipation environment; and (iv) spill sequestering environment.

Advantages of the protective cover herein include at least the following: (1) a customized individual stovetop heat resistant protectors which come in a set of three distinct sections; (2) the three distinct sections cover and protect the surface of the stovetop; (3) the three distinct section uniquely sits flat in each individual stovetop section; and (4) a facile setup for cleaning a single distinct section, two distinct sections, or three distinct sections.

The removal of burnt-on grease from the surface of or crevices of a stovetop is often a tedious endeavor. Most operators of the stovetop simply place a single large piece or pieces of aluminum foil over the entire stovetop, while cutting holes within the aluminum foil to be placed around the burners. Spilled items, such as food or water, are on the stovetop are inevitable. The entire top assembly of heavy grates, cast-iron griddles, or other burdensome removable parts are performed for cleaning. Additionally, the aluminum foil must be removed to maintain the stainless steel of the stovetop from corrosion and dirt. stovetop clean again.

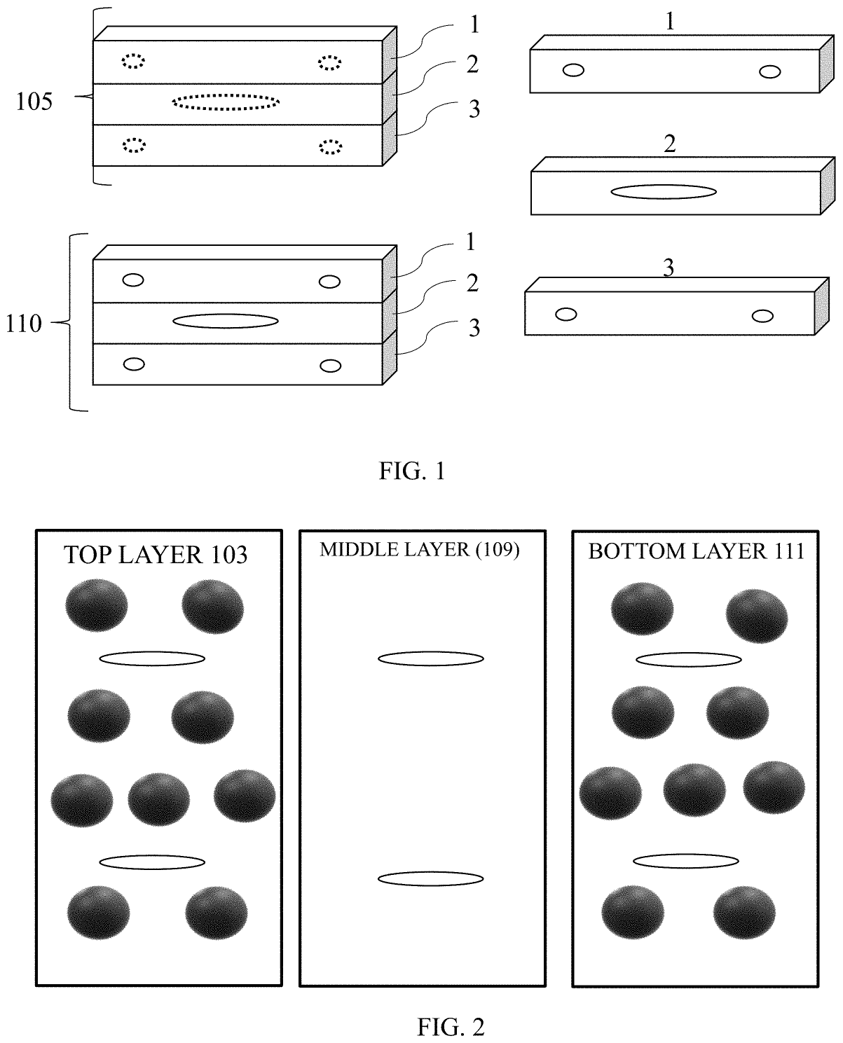

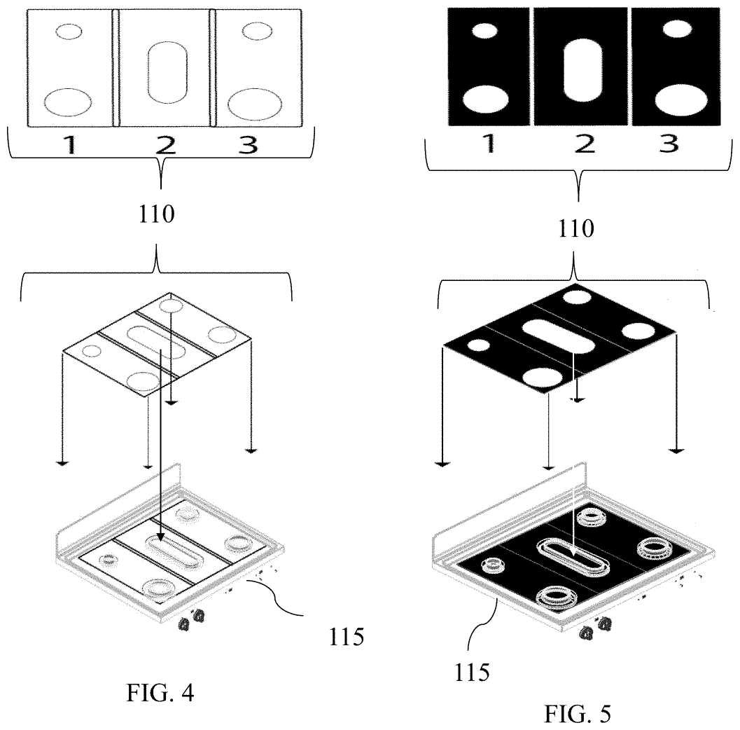

The majority of consumer gas or electric powered stovetops have a five-burner configuration divided into distinct sections (e.g., 1, 2, and 3 in FIG. 1, FIG. 4, and FIG. 5). For example, there are three distinct sections in the protective coverings herein, as depicted in FIG. 1, FIG. 4, and FIG. 5. The distinct section can function autonomously from each other. This allows for heavy grates, cast-iron griddles, or other burdensome removable parts to be placed on or removed from the distinct sections. If an immediate cleanup or modification needs to be performed, only one of the distinct sections needs to be attended to. When operating the stovetop with the protective coverings herein placed over the surface of the housing unit or base of the stove top and around the burners, the autonomous environment, as provided by the three distinct sections, allows for sections be cleaned separately rather than when there are food spills, stains, leftover residues, and oil splashes into the inner stovetop. This obviates the need to completely disassemble portions of the stovetop during cleanups.

The surface of stovetop sections is not: (i) always flush with the top counter surface and (ii) completely flat (i.e., there are ridges and other heterogeneities on the surface), The middle burner section is often raised making an uneven surface.

Sheet 105 is the basis for the protective covers herein composed of PTFE, which is absent of carcinogenic PFOA. Portions of sheet 105 are removed, which are demarked by the dotted lines. The portions corresponding to the dotted lines are excised from sheet 105 to yield the cutouts in sheet 110. Sheet 110 is the protective cover herein contains cutouts configured for placement over the respective burners. PTFE sheets 105 and 110 are resistant to tearing and heat accumulation.

In the examples depicted in FIG. 2 (and FIGS. 4-5), there are five cutouts for five burners. In other embodiments, there are fewer than five cutouts. In other embodiments, there are more than five cutouts. On the left side of FIG. 1, sections 1, 2, and 3 in sheet 110 are depicted as adjacent to each other where section 1 is adjacent to section 2 and section 2 is adjacent to section 3. Upon further separating the adjoined sections from each other, the right-side depiction of section 110 results. On the right side of FIG. 1, sections 1, 2, and 3 in sheet 110 are depicted as distinct and separate from each other.

The protective covers herein comprise a top layer (103), a middle layer (109), and bottom layer (111), as depicted in FIG. 2. The middle layer (109) is sandwiched in between the top layer (103) and the bottom layer (111). The middle layer (109) is absent of ridges. The top layer (103) and bottom layer (111) each have ridges. Each of the top layer (103) and bottom layer (111) have a top surface and a bottom surface. The bottom surface of the top layer (103) and the top surface of the bottom layer (111) are in direct contact with the middle layer (109). The top surface of the top layer (103) and the bottom surface of the bottom layer (111) each comprise a plurality of ridges. The ridges on the bottom layer (111) are in contact with the stovetop. The ridges on the top layer (103) are arranged and configured to receive and sequester spilled items.

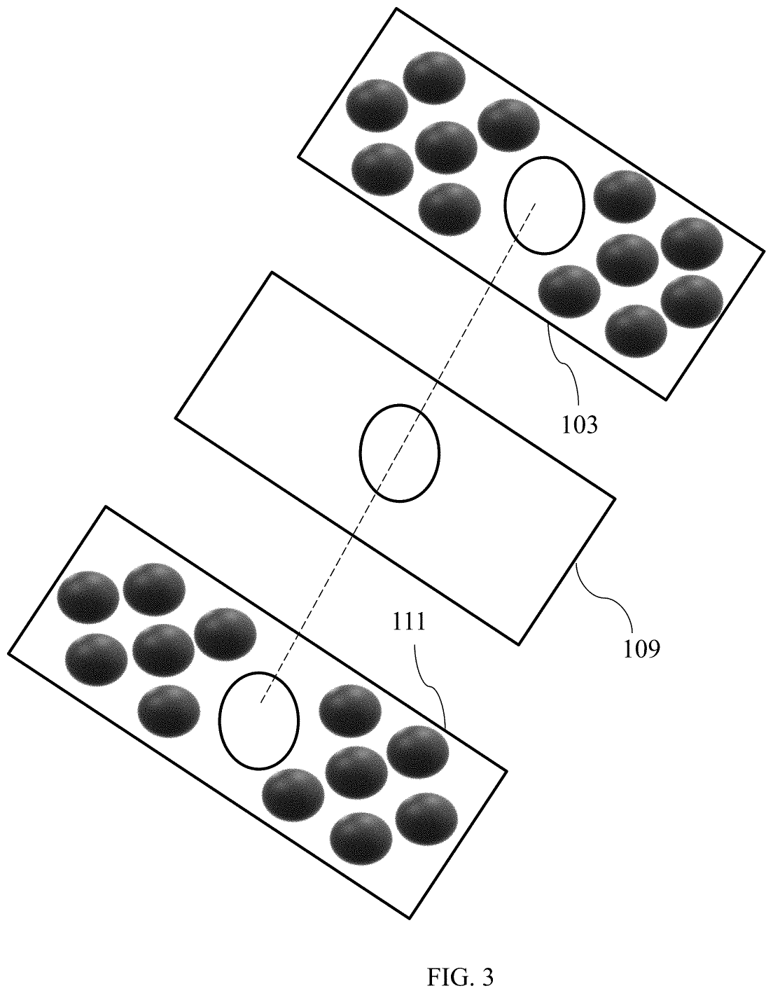

There are two sets of ridge arrangements in the bottom layer (111) and top layer (103), such that valleys form along the bottom surface of the bottom layer (111) and the top surface of the top layer (103). Each valley is surrounded by four ridges, as depicted in FIG. 3. The surface area of the protective cover herein is increased, thereby dissipating received heat across the valleys and ridges. The protective cover herein is resistant to heat accumulation, thereby preventing the protective cover herein from melting and fusing onto the surface of the stovetop. The formed valleys are also spill sequestering environments, as the ridges form walls for encompassing the spilled items within. The non-sticky surface prevents adhesion of the spilled items with the ridge or valleys, which allows for facile cleanup.

The two sets of ridge arrangements and the resulting valleys on the bottom layer (111) are pliable and thus able to comport to elevated surfaces and heterogeneities on the surface to create a sturdy yet removable fit. The bottom layer is therefore a comported topology. The middle layer (109) provides a separative elevation surface for further separating the comported topology from the top layer (103). The respective top layers (103) of each section are on the same level as each other (i.e., planar). Therefore, a planar, non-sticky, spill sequestering, and heat dissipating environment is achieved when the protective covering herein is placed over the operating stovetop.

Note: only a portion of the ridges and set of ridge arrangements are depicted for the purposes of simplicity.

The cutouts of the top layer (103), middle layer (109), and bottom layer (111) are directly above each other, as depicted in the dotted lines in FIG. 3.

Stovetop manufacturers are currently moving to paint the stainless steel to black due to these cleaning issues described above. As depicted in FIG. 4 and FIG. 5, a set of three distinct sections of the protective covering (sheet 110) is an eco-friendly, high-quality, portable, easily removable, placeable, and washable setup. Stovetop 115 contains individual grates, cast-iron griddles, and other removable parts. Sections 1 and 3 each contain a smaller cutout on the top portion and a larger cutout on the bottom portion. Section 2 contains a single wide cutout. Sections 1, 2, and 3 can be placed and removed one at a time if needed. The cutouts can be placed around the flanges on the surfaces of stovetop 115, as depicted by the arrows. The flanges protrude above the surface of sheet 110.

The metal portions of the surface of the stovetop can be cleaned without chemicals. These chemicals placed on the metal are ecologically unsafe and hazardous due to the tendency to remain in trace amounts, which are still toxic to humans. Therefore, one, two, or all three of the sections can be easily washed off and placed over the metal surface. More specifically, protective coverings herein obviate the need to use commercial oven cleaners or even manufacturer recommended cleaners.

What is claimed is:

1. A cover placed for a stove top, comprising:
a plurality of sections composed of a fire-resistant polymer, wherein each section comprises:
a top layer comprising a first plurality of cutouts and a first plurality of ridges, wherein the first plurality of ridges is disposed on a top surface of the top layer;
a bottom layer comprising a second plurality of cutouts and a second plurality of ridges, wherein the second plurality of ridges is disposed on a bottom surface of the bottom layer;
a middle layer comprising a third plurality of cutouts, wherein the middle layer is disposed in between a bottom surface of the top layer and a top surface of the bottom layer;
wherein the first plurality of cutouts is disposed over the second plurality of cutouts, wherein the second plurality of cutouts is disposed over the third plurality of cutouts;
wherein the first plurality of ridges comprises a first arrangement of ridges and a second arrangement of ridges;
wherein the second plurality of ridges comprises a first arrangement of ridges and a second arrangement of ridges; and
wherein the stove top comprises burners and a housing unit.

2. The cover of claim 1, wherein the first plurality of cutouts and the second plurality of cutouts are configured to fit around the burners of the stove top.

3. The cover of claim 1, wherein the bottom layer is configured to contact the housing unit.

4. The cover of claim 1, wherein the fire-resistant polymer is polytetrafluoroethylene (PTFE).

5. The cover of claim 1, wherein the bottom layer, the middle layer, and the top layer are configured to adopt to uneven surfaces of the housing unit.

6. The cover of claim 1, wherein the fire-resistant polymer is non-sticky.

7. The cover of claim 1, wherein the second plurality of ridges dissipates heat in contact with the plurality of sections.

8. The cover of claim 1, wherein the first and second arrangements of ridges of the top layer are configured to sequester items within the first and second arrangements of ridges of the top layer.

9. The cover of claim 1, wherein the items comprise liquid and food.

10. The cover of claim 1, wherein the heat resistant polymer is certified as: heat resistant per Food and Drug Administration (FDA) standards and absent of perfluorooctanoic acid (PFOA).
